(19) United States
(12) Patent Application Publication
(10) Pub. No.: US 2006/0086181 A1
(43) Pub. Date: Apr. 27, 2006

(54) Combustion device control system for use in an engine

(75) Inventor: Dong Woo Nam, Incheon (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: Doosan Infracore Co., Ltd.

(21) Appl. No.: 11/255,305

(22) Filed: Oct. 20, 2005

(30) Foreign Application Priority Data
Oct. 22, 2004 (KR) 2004-0084894

(51) Int. Cl. G01M 15/00; G01L 3/02

(52) U.S. Cl. 73/116; 73/117.3; 73/862.191

(57) ABSTRACT

An engine combustion device control system is disclosed, wherein, as a flywheel 10 rotates, a detection sensor 70 detects indexes 20a formed on an inner surface of the flywheel 10 to accurately measure the number of engine revolutions and a piston position. The indexes 20a are formed along a circle concentric with a rotational center of the flywheel at a substantially equal spacing and grouped to fall into different kinds of discrete angular sections, making it possible to accurately estimate the number of engine revolutions and the time at which a piston reaches a top dead point. This removes the need for a separate rotating disk other than the flywheel and enables an electronic control unit of an engine to control the timing of injection and ignition of mixed gas in an accurate manner.

Pursuant to 35 U.S.C. § 119(a), this application claims the benefit of earlier filing date and right of priority to Korean Patent Application No. 10-2004-0084894, filed on Oct. 22, 2004, the content of which is hereby incorporated by reference herein in its entirety.

### BACKGROUND OF THE INVENTION

1. Field of the Invention

The present invention is directed to a combustion device control system for use in an engine, and more specifically to an engine combustion device control system that can accurately detect a piston position for providing a crankshaft with a rotational force, by detecting the number of engine revolutions and a rotation angle of the crankshaft separate external gadget. Also the instant invention pertains to an engine combustion device control system that controls fuel injection timing depending on a piston position.

2. Description of the Related Art

State-of-the-art internal combustion engines usually employ an Electronic Control Unit (ECU) that controls a ratio of fuel-air mixture, an injection amount of mixed gas and an injection timing of such mixed gas in a computerized manner.

Such an electronically controlled engine is designed to induce perfect fuel combustion by allowing the mixed gas to be injected into a cylinder in an air-fuel ratio close to a theoretical one. This enhances engine output power and reduces emission of harmful components produced at the time of incomplete fuel combustion.

In order for the electronically controlled engine to generate an optimized output power through the perfect fuel combustion, it is important to inject and explode the mixed gas in a timely fashion. Namely, it is essential that the injection and ignition timing of the mixed gas should be tuned up properly. Accurate detection of the number of engine revolutions and a piston position is needed to appropriately tune up the injection and ignition timing of the mixed gas.

Conventionally, use has been made of a detection device that comprises a separate rotating disk drivingly associated with a crankshaft, a dog mounted to a predefined point on the rotating disk and a sensor for detecting movement of the dog to thereby detect the number of engine revolutions and a piston position.

One of the problems posed in the conventional detection device is that the number of engine revolutions and a piston position cannot be detected in a precise and accurate manner. With a view to improving such problems, an engine has to be modified fundamentally or a separate component other than basic engine parts must be employed additionally.

Furthermore, the number of engine revolutions and a piston position are detected in the conventional detection device by way of sensing a reference tooth on a rotating disk through the use of a crank position sensor. This means that the conventional detection device cannot accurately detect the number of engine revolutions and, particularly, a piston position, until and unless the rotating disk attached to a crankshaft makes one full rotation for the crank position sensor to detect the rotation of the disk. In other words, the entire sector of the rotating disk except for the reference tooth part constitutes a non-detected section where the detection device lacks an ability to accurately detect a piston position.

Inaccurate detection of the number of engine revolutions and a piston position makes it difficult to properly control injection and ignition timing of mixed gas, which may give rise to several problems including a decreased engine output power and an increased emission of harmful exhaust gases from an engine.

### SUMMARY OF THE INVENTION

Accordingly, the present invention is conceived to solve the problems noted above, and it is an object of the present invention to provide an engine combustion device control system that can reduce a non-detected section to thereby assure an accurate detection of a piston position and enable an engine combustion device to be driven with optimized timing of injection and ignition of mixed gas.

Another object of the present invention is to provide an engine combustion device control system that has an ability to detect the number of engine revolutions with the use of a means for accurately detecting a piston position.

A further object of the present invention is to provide an engine combustion device control system that enables an engine to inject and ignite mixed gas at an optimized timing, thus maximizing efficiency of the engine, by providing a combustion device with the information on optimized injection and ignition timing of the mixed gas.

With these objects in view, there is provided a combustion device control system for use in an engine having at least one piston capable of reciprocating movement, comprising: a flywheel; at least one detection sensor; and an electronic control unit.

The flywheel is adapted to rotate in concert with the reciprocating movement of the piston and has a plurality of structurally formed patterns (referred to as “indexes” hereinbelow) provided along a circle concentric with a rotational center of the flywheel at a substantially equal spacing, the indexes grouped to fall into different kinds of discrete angular sections. The detection sensor is fixedly attached to a body of the engine in a confronting and adjoining relationship with the indexes of the flywheel for sensing the indexes to generate different sensor signals on a section-by-section basis. And, the electronic control unit recognizes a piston position in response to at least one of the index information and section information contained in the sensor signals.

Moreover, the electronic control unit calculates the number of engine revolutions per hour, based on the sensor signals, and estimates the time at which the piston reaches a specific position, based on a rotational speed of the engine corresponding to the number of engine revolutions and piston position information corresponding to the section information.

One of the indexes is formed at such a position that it can be sensed by the detection sensor when the piston reaches a top dead point.

Preferably, the indexes are equally spaced at a first spacing in each of the angular sections and at a second spacing different than the first spacing in borders between the angular sections, and the angular sections are distinguished from one another by the number of the indexes contained in each of the sections.

The indexes are formed on either an inner flank side or an outer circumference of the flywheel and comprise dogs, through-holes and blind holes any of which being disposed in each of the angular sections at the first spacing, and the detection sensor comprises an inductive sensor for generating predetermined pulses corresponding to the indexes as the sensor signals.

Preferably, the indexes comprise the dogs, the through-holes and the blind holes, any of which being disposed in the borders of the angular sections at the second spacing.

In the meantime, the detection sensor is selected from the group consisting of an inductive sensor, an infrared sensor, a photo sensor, an ultrasonic sensor and a proximity sensor.

According to another embodiment of the present invention, the combustion device comprises: a fuel injection nozzle; and a distributor. The fuel injection nozzle is controlled by the electronic control unit to inject a mixed air into a combustion chamber at the moment when the piston reaches a predefined position, whereas the distributor is controlled by the electronic control unit in such a manner that it can ignite the mixed gas at the time when the piston reaches the predefined position, i.e., at a top dead point of the piston. In this fashion, the electronic control unit controls the fuel injection nozzle and the distributor based on information of a piston position detected by the detection sensor. This ensures that the engine combustion device control system according to the present invention can control the injection and ignition timing of the mixed gas in an optimized manner, thus maximizing the efficiency of the engine of converting a thermal energy to a kinetic energy.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 shows an overall construction of an engine combustion device control system according to the present invention;

FIG. 2 is a cross-sectional view taken along line 0-0 in FIG. 1;

FIG. 3 is a perspective view illustrating a flywheel incorporating indexes in accordance with one embodiment of the present invention;

FIG. 4 illustrates a flywheel having indexes in accordance with another embodiment of the present invention;

FIG. 5 is a waveform diagram showing shapes of pulses generated by a detection sensor illustrated in FIG. 3; and

FIG. 6 is a block diagram showing an engine combustion device control circuit that incorporates an electronic control unit in accordance with one embodiment of the present invention.

### DETAILED DESCRIPTION OF THE INVENTION

Now, certain preferred embodiments of an engine combustion device control system according to the present invention will be described in detail with reference to the drawings attached.

An engine combustion device control system according to the present invention comprises: a flywheel affixed to one end of a crankshaft that converts a reciprocating movement of a piston to a rotational motion of the flywheel and having a plurality of indexes structurally formed on the flywheel; and a detection sensor fixedly attached to a body of the engine in a confronting and adjoining relationship with the indexes of the flywheel for generating predetermined sensor signals corresponding to the indexes. The indexes are formed along a circle concentric with a rotational center of the flywheel at a substantially equal spacing so that the detection sensor can detect the number of engine revolutions and a piston position even if the flywheel fails to make one full rotation. Namely, the detection sensor detects an in-cylinder piston position drivingly connected to the flywheel via the crankshaft.

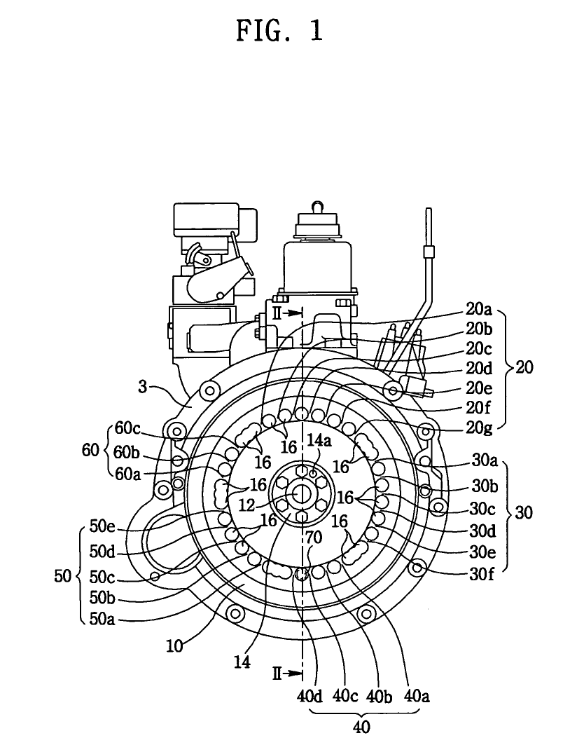

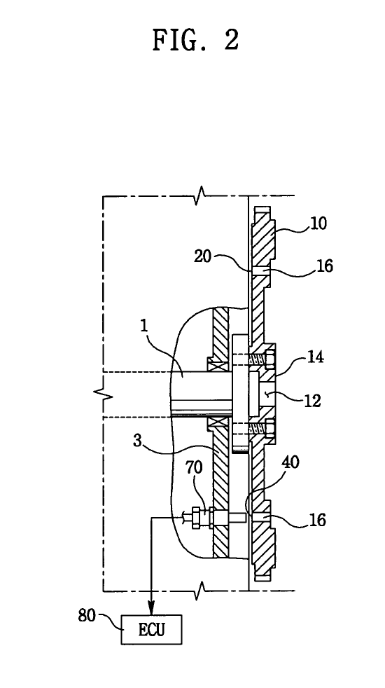

Referring first to FIGS. 1 and 2, description is offered on the construction of an engine combustion device control system in accordance with one embodiment of the present invention. Among the construction shown in FIGS. 1 and 2, non-essential parts in the present invention will not be set forth for the sake of simplicity. Furthermore, the following description will proceed by taking an instance that position detection is performed for a single piston. In a typical engine, a plurality of pistons are connected to a crankshaft at the same angle, meaning that, if a position of one piston is detected, the positions of other pistons can be easily recognized.

The engine combustion device control system according to the present invention comprises: a flywheel 10 on which a plurality of indexes are formed in a predetermined pattern; a detection sensor 70; and an electronic control unit 80. The engine combustion device control system may constitute a part of an engine system.

The flywheel 10 is provided at one side of an engine 100 and fixedly secured to one end of a crank shaft 1 in such a manner that the flywheel 10 and the crankshaft 1 have the same axis of rotation. The crankshaft 1 is provided with cranks of different angular phases to which pistons (not shown) are swingably connected. Going through intake, compression, explosion and exhaust strokes, the pistons are subjected to a reciprocating movement which in turn is converted to a rotational movement of the crankshaft 1. The crankshaft 1 causes the flywheel 10 to rotate, while keeping the engine 100 in smooth operation. As viewed in FIG. 1, the flywheel 10 rotates counterclockwise.

The engine combustion device control system according to the present invention can accurately recognize the number of engine revolutions by virtue of measuring the rotational speed of the flywheel 10.

Referring again to FIG. 1, a dowel pin 14a is affixed to a boss 14 projecting around a center bore 12 of the flywheel 10. The dowel pin 14a is so disposed that it can assume a lowest position when a piston reaches a top dead point. This makes it sure that the engine combustion device control system can precisely detect the top dead point of the piston by sensing the rotation of the flywheel 10.

Formed on the flywheel 10 are a plurality of indexes for inducing the detection sensor 70 to generate sensor signals, whose indexes may be of different configurations depending on the kind of the detection sensor 70. The indexes are formed along a circle concentric with a rotational center of the flywheel 10 at a substantially equal spacing so that the number of engine revolutions can be detected even though the flywheel 10 fails to make one full rotation. Disposing the indexes at the substantially equal spacing helps maintain the balance of the flywheel 10.

The indexes are grouped to fall into discrete angular sections and have different patterns in each of the sections such that the position corresponding to the top dead point of the piston, i.e., the position of the dowel pin 14a can be estimated in advance. The angular sections are distinguished by the amplitude and the number of pulses generated from the detection sensor 70 during one rotation of the flywheel 10, which means that the indexes in each of the sections should be formed differently. The angular sections will be referred to as “rotation angle indicating portions” hereinbelow. As for the indexes formed on the flywheel 10, detailed description will be made infra.

The detection sensor 70 is fixedly attached to a body of the engine 100 in a confronting and adjoining relationship with the indexes of the flywheel 10 and kept stationary against the rotation of the flywheel 10. Examples of the detection sensor 70 include an inductive sensor, an infrared sensor, a photo sensor, an ultrasonic sensor and a proximity sensor. The detection sensor 70 is adapted to sense the indexes on the flywheel 10 and feed sensor signals of a predefined pattern recycling every rotation of the flywheel 10 to the electronic control unit 80. The electronic control unit 80 can extract index information and section information from the sensor signals supplied by the detection sensor 70.

In one embodiment of the present invention, the inductive sensor is used by taking into account that the inductive sensor can produce pulses in response to the distance change between the indexes, and the pulse amplitude of which varies with the rotational speed of the flywheel 10 so that the number of engine revolutions can be measured by use of the pulse amplitude.

Although a single detection sensor is employed in accordance with the embodiment of the present invention, it would be possible to use a multiple number of detection sensors in an effort to enhance the system reliability.

The electronic control unit 80 determines the number of engine revolutions and the top dead point piston position, based on the index information and the section information extracted from the detection sensor 70. In this manner, the electronic control unit 80 can accurately recognize a piston position and the number of engine revolutions and, on the basis of this recognition, can properly control the timing of injection and ignition of the mixed gas in a combustion device.

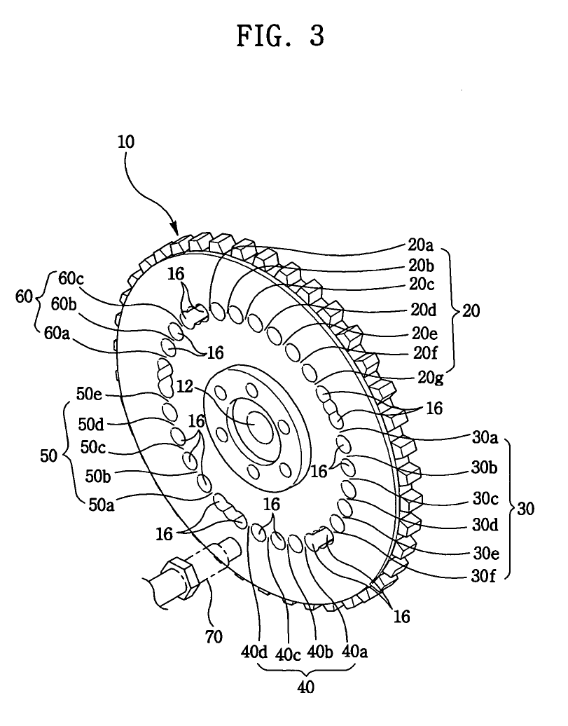

A flywheel having indexes according to one embodiment of the present invention will now be described with reference to FIG. 3. Also set forth are operations of the detection sensor 70 and the electronic control unit 80 in that case. An inductive sensor is used as the detection sensor 70 in the embodiment shown in FIG. 3 by way of example.

Operation of the detection sensor 70 is induced by the indexes. An inductive sensor as the detection sensor 70 can generate signals in response to the variation of distance between magnetic substances spaced a predetermined distance apart. In order to cause the distance variation, an array of through-holes, blind holes or dogs is formed on the flywheel 10 in such a manner that the indexes can be provided in between the holes or the dogs.

According to the preferred embodiment illustrated in FIG. 3, five angular sections, i.e., first through fifth rotation angle indicating portions 20, 30, 40, 50, and 60 are formed on the inner flank side of the flywheel 10 in a circumferential direction. Alternatively, the indexes of the flywheel 10 may be grouped to fall into other number of rotation angle indicating portions than five.

The first through fifth rotation angle indicating portions 20, 30, 40, 50, and 60 are disposed along a circle concentric with the center bore 12 of the flywheel 10. In other words, the first through fifth rotation angle indicating portions 20, 30, 40, 50, and 60 are formed in a spaced-apart relationship with one another in the named sequence.

Each of the first through fifth rotation angle indicating portions 20, 30, 40, 50, and 60 contains blind holes 16 so formed as to leave indexes therebetween. Different numbers of indexes are provided in each of the rotation angle indicating portions. Accordingly, in the preferred embodiment illustrated in FIG. 3, the rotation angle indicating portions can be distinguished by the number of pulses that the detection sensor 70 generates through detection of the indexes.

In a case that the rotation angle indicating portions are divided into other numbers than five, the number of the indexes belonging to each of the rotation angle indicating portions should differ from one another to ensure that different numbers of pulses can be produced for every rotation angle indicating portions. The length of the rotation angle indicating portions differs from one another because the indexes in each of the rotation angle indicating portions have the same spacing but differ in numbers. If, however, the rotation angle indicating portions are distinguished by other factors than the number of pulses, the rotation angle indicating portions may be identical in length. For instance, the rotation angle indicating portions can be distinguished by the pulse amplitude, in which case the depth of blind holes or the like should vary with the rotation angle indicating portions to produce pulses of different amplitudes.

In the embodiment shown in FIG. 3, the angular sections are distinguished by the number of indexes. Accordingly, the first through fifth rotation angle indicating portions 20, 30, 40, 50, and 60 contain different numbers of indexes, viz., seven, six, four, five and three indexes in the named order.

More specifically, the first rotation angle indicating portion 20 consists of seven, equally spaced indexes 20a, 20b, 20c, 20d, 20e, 20f and 20g, the second rotation angle indicating portion 30 consists of six, equally spaced indexes 30a, 30b, 30c, 30d, 30e and 20f, the third rotation angle indicating portion 40 consists of four, equally spaced indexes 40a, 40b, 40c and 40d, the fourth rotation angle indicating portion 50 consists of five, equally spaced indexes 50a, 50b, 50c, 50d and 30e, and the fifth rotation angle indicating portion 60 consists of three, equally spaced indexes 60a, 60b and 60c.

As an alternative, the rotation angle indicating portions may contain other number of indexes than seven, six, four, five and three. Adopting different numbers of indexes will suffice for distinguishing the rotation angle indicating portions. Instead of changing the number of pulses, it will be equally possible to change the pulse amplitude generated by the detection sensor 70 for the purpose of discriminating the rotation angle indicating portions from one another.

The dogs, through-holes or blind holes are formed with a longer length in borders between the rotation angle indicating portions 20, 30, 40, 50, and 60 than inside the portions.

The first rotation angle indicating portion 20 is disposed in alignment with the dowel pin 14a, as best shown in FIG. 1. This assures that the detection sensor 70 can recognize the arrival at the top dead point of the piston by sensing the first rotation angle indicating portion 20. Particularly, the first rotation angle indicating portion 20 is so disposed that the sixth index 20f of seven indexes 20a, 20b, 20c, 20d, 20e, 20f and 20g can be aligned with the dowel pin 14a.

The detection sensor 70 is positioned such that it can confront one of the indexes formed on the flywheel 10. It can be seen in FIG. 1 that the detection sensor 70 is in exact alignment with the index moved to the lower most position during the process of rotation of the flywheel 10.

The detection sensor 70 senses the change of magnetic fields and generates a predetermined number of pulses every time each of the rotation angle indicating portions moves past the lower most position where the detection sensor 70 lies. In other words, the detection sensor 70 is adapted to produce different numbers of pulses corresponding to those of indexes contained in each of the first through fifth rotation angle indicating portions 20, 30, 40, 50, and 60.

In the illustrated embodiment, the detection sensor 70 generates seven pulses in correspondence to the number of indexes 20a, 20b, 20c, 20d, 20e, 20f and 20g of the first rotation angle indicating portion 20, six pulses in correspondence to the number of indexes 30a, 30b, 30c, 30d, 30e and 30f of the second rotation angle indicating portion 30, four pulses in correspondence to the number of indexes 40a, 40b, 40c and 40d of the third rotation angle indicating portion 40, five pulses in correspondence to the number of indexes 50a, 50b, 50c, 50d and 50e of the fourth rotation angle indicating portion 50, and three pulses in correspondence to the number of indexes 60a, 60b and 60c of the fifth rotation angle indicating portion 60.

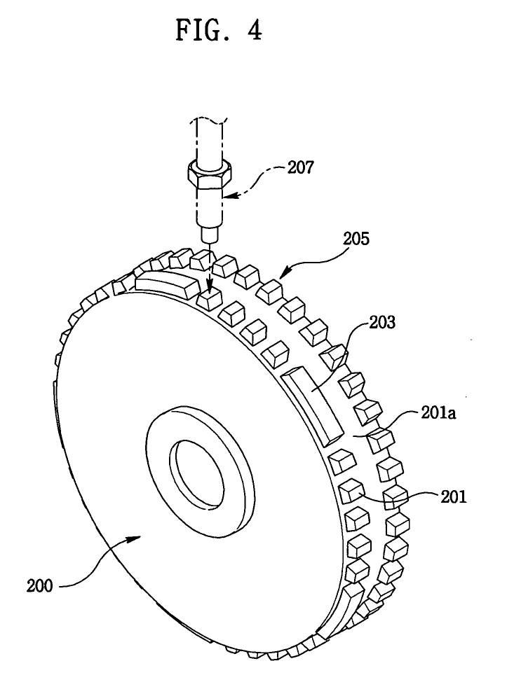

FIG. 4 illustrates a flywheel having indexes in accordance with another embodiment of the present invention. Referring to FIG. 4, each index is provided in the form of a dog 201 along an outer circumference 200a, and not on an inner flank side, of a flywheel 200 in a parallel relationship with the teeth 205 that receive a driving force from a starting motor (not shown). Dogs 203 longer in length than the dogs 201 are used to divide angular sections composed of the dogs 201.

Like in the embodiment shown in FIG. 3, the detection sensor 207 is fixedly attached to a body, i.e., a cylinder block, of an engine in a confronting and adjoining relationship with the indexes of the flywheel 200 and kept stationary against rotation of the flywheel 200. As shown in FIG. 4, the detection sensor 207 is radially disposed outward from the outer circumference 200a of the flywheel 200 on a normal line passing the center of the flywheel 200 in a confronting relationship with the indexes.

Unlike in the embodiments illustrated in FIGS. 3 and 4, the detection sensor may be an infrared sensor or a proximity sensor, in which case the indexes should be changed to those that match the sensor employed. In the event that an infrared sensor with light emitting and light receiving parts is employed, the indexes may be reflex mirrors disposed in the same manner as in the embodiments of FIGS. 3 and 4.

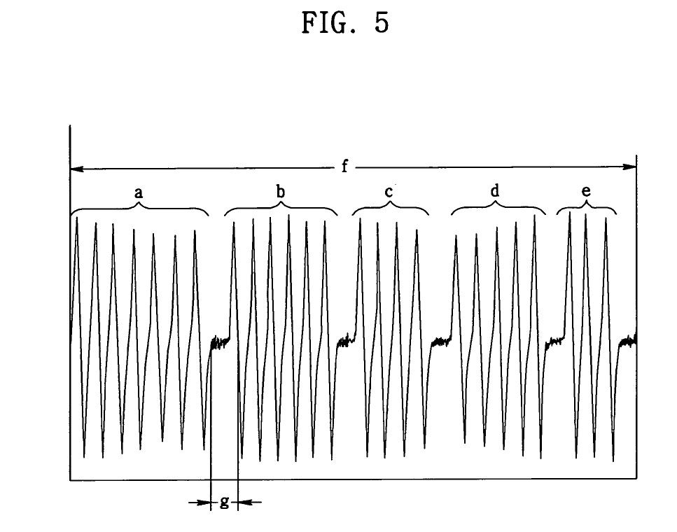

FIG. 5 is a waveform diagram showing the shapes of pulses generated by a detection sensor shown in FIG. 3, wherein the abscissa denotes a time (t) and the ordinate indicates a voltage (v).

Shown in FIG. 5 are a plurality of pulse arrays (a, b, c, d and e) generated in correspondence to the five rotation angle indicating portions 20, 30, 40, 50, and 60. Each of the pulse arrays constitutes a blind span (f) of a predetermined time period and is repeated with a time interval (g) taken in one up-and-down movement of a piston. Index information and section information are contained in the waveform of signals generated by the detection sensor 70 or 203. Individual pulses provide the index information, while the pulse arrays of the blind span (f) carry the section information.

The specific number of pulses generated by the detection sensor 70 in correspondence to the respective rotation angle indicating portions 20, 30, 40, 50, and 60 are inputted to an electronic control unit 80 which in turn extracts the section information from the pulse arrays and, based on the section information, recognizes a rotation angle of the flywheel 10 corresponding to the respective rotation angle indicating portions 20, 30, 40, 50, and 60. As the rotation angle of the flywheel 10 is recognized, the electronic control unit 80 can accurately determine a piston position.

The electronic control unit 80 can also accurately recognize the number of engine revolutions by extracting the index information from the pulse arrays. In a case of using an inductive sensor as the detection sensor 70, the electronic control unit 80 can determine the number of engine revolutions from the individual pulses amplitude.

Eventually, seven, six, four, five and three pulses are sequentially generated in keeping with the operation of an engine, and the electronic control unit 80 accurately recognizes a piston position corresponding to the respective pulse arrays to thereby properly control the timing of injection and ignition of mixed gas.

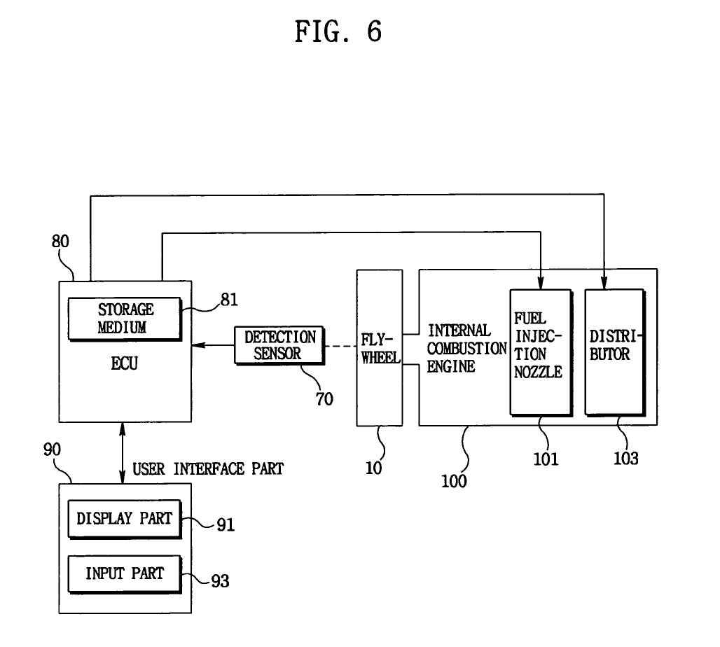

Operation of the electronic control unit according to one embodiment of the present invention will now be described with reference to FIG. 6 that schematically shows a block diagram of an engine combustion device control circuit.

Referring to FIG. 6, an electronic control unit 80 comprises a specific type of storage medium 81 and is electrically connected to a detection sensor 70, a user interface part 90, a fuel injection nozzle 101 and a distributor 103. For reference, it should be appreciated that the control circuit shown in FIG. 6 is not devoted to the present invention but may be applied to a fuel injection control device for a general engine capable of detecting the number of engine revolutions and a piston position. Furthermore, the control circuit shown in FIG. 6 may be represented differently while substantially including the same function of detecting the number of engine revolutions and the piston position.

The electronic control unit 80 essentially controls the overall operations of the engine 100 and further recognizes the number of engine revolutions and a piston position in response to the signals received from the detection sensor 70, as a result of which the electronic control unit 80 can control the fuel injection nozzle 101 and the distributor 103 through the use of the signals thus received.

Even when the flywheel 10 makes an angular movement less than one rotation, the electronic control unit 80 can calculate the number of engine revolutions by using the pulse arrays received from the detection sensor 70, the waveform of which is illustrated in FIG. 5. As the engine speed increases, the electronic control unit 80 continues to refresh the number of engine revolutions and provides the refreshed number of engine revolutions to the view of a user through a display part 91.

The electronic control unit 80 can determine a piston position and hence estimate the time at which the piston reaches a top dead point, if at least one rotation angle indicating portion moves past the detection sensor 70. Turning back to FIG. 5, once the pulse array of three pulses corresponding to the fifth rotation angle indicating portion 60 is outputted from the detection sensor 70, the electronic control unit 80 makes an estimation that the piston will reach the top dead point after a predetermined time, i.e., the time of one blind (g) plus the time corresponding to the pulse array (a) of the first rotation angle indicating portion, has lapsed. Since the time corresponding to a specific pulse array has a correlation with the number of engine revolutions, the electronic control unit 80 can calculate the number of engine revolutions and, based on the number of engine revolutions thus calculated, can estimate the time when the piston reaches the top dead point. This means that the electronic control unit 80 is capable of properly controlling the timing of injection and ignition of mixed gas even at an engine cranking time when the engine 100 has not made one full rotation.

The storage medium 81 can store a variety of programs, information needed for operation of the electronic control unit 80, piston position information corresponding to the number of pulses generated by the detection sensor 70, information on the number of engine revolutions corresponding to the pulse amplitudes, and information on the number of engine revolutions corresponding to the number of pulses outputted per hour.

Particularly, the electronic control unit 80 can accurately determine that the piston has reached the top dead point, as the detection sensor 70 consecutively senses the fifth rotation angle indicating portion 60 and the first rotation angle indicating portion 20 to thereby generate an array of three pulses and an array of seven pulses.

The user interface part 90 comprises: a display part 91; and an input part 93. The display part 91 serves to display to the view of a user a variety of information received from the electronic control unit 80, whose information includes the number of engine revolutions calculated by the electronic control unit 80. The input part 93 allows the user to enter various commands into the electronic control unit 80 therethrough.

Under a control of the electronic control unit 80, the fuel injection nozzle 101 injects mixed gas into the engine 100, and the distributor 103 enables an ignition plug (not shown) to ignite the mixed gas when the piston is at the top dead point.

As is apparent from the foregoing description, the engine combustion device control system according to the present invention can accurately recognize the number of engine revolutions and a piston position by the combined use of indexes and a detection sensor, thus enabling an electronic control unit to properly control the timing of injection and ignition of mixed gas.

Furthermore, by way of estimating in advance the time for a piston to reach a top dead point or other positions, it becomes possible to accurately predict the arrival at a specific piston position even when an engine operates at a lower speed, e.g., at an engine cranking time.

The engine combustion device control system according to the present invention makes no use of such wheels for the detection of engine rotation as a separate rotating disk and the like, thereby enhancing the freedom of engine design. In addition, use of a non-contact type sensor helps improve the durability of an engine.

The engine combustion device control system according to the present invention assures that the time for a piston to reach a top dead point and the number of engine revolutions can be estimated and calculated in an accurate and reliable manner through the use of indexes of novel design.

Although certain preferred embodiments of the present invention have been described in the foregoing, it will be apparent to those skilled in the art that various changes or modifications may be made thereto within the scope of the invention defined by the appended claims.

What is claimed is:

1. A combustion device control system for use in an engine having at least one piston capable of reciprocating movement, comprising:
a flywheel rotating in concert with the reciprocating movement of the piston and having a plurality of indexes provided along a circle concentric with a rotational center of the flywheel at a substantially equal spacing, the indexes grouped to fall into different kinds of discrete angular sections;
at least one detection sensor fixedly attached to a body of the engine in a confronting and adjoining relationship with the indexes of the flywheel for sensing the indexes to generate different sensor signals on a section-by-section basis; and
an electronic control unit for detecting a piston position in response to at least one of index information and section information contained in the sensor signals and for feeding operation signals to a combustion device of the engine at the time when the piston reaches a predefined position.

2. The system as recited in claim 1, wherein the electronic control unit calculates the number of engine revolutions per hour, based on the sensor signals, and estimates the time at which the piston reaches a specific position, based on a rotational speed of the engine corresponding to the number of engine revolutions and piston position information corresponding to the section information.

3. The system as recited in claim 1, wherein one of the indexes is formed at such a position that it can be sensed by the detection sensor when the piston reaches a top dead point.

4. The system as recited in claim 1, wherein the indexes are equally spaced at a first spacing in each of the angular sections and at a second spacing different than the first spacing in borders between the angular sections, and wherein the angular sections are distinguished from one another by the number of the indexes contained in each of the sections.

5. The system as recited in claim 4, wherein the indexes are formed on either an inner flank side or an outer circumference of the flywheel and comprise dogs, through-holes and blind holes any of which being disposed in each of the angular sections at the first spacing, and wherein the detection sensor comprises an inductive sensor for generating predetermined pulses corresponding to the indexes as the sensor signals.

6. The system as recited in claim 5, wherein the indexes comprise the dogs, the through-holes and the blind holes any of which being disposed in the borders of the angular sections at the second spacing.

7. The system as recited in claim 1, wherein the detection sensor is selected from the group consisting of an inductive sensor, an infrared sensor, a photo sensor, an ultrasonic sensor and a proximity sensor.

8. The system as recited in claim 1, wherein the combustion device comprises a fuel injection nozzle for injecting fuel into the air to produce mixed gas and a distributor for igniting the mixed gas, and wherein the electronic control unit issues an operation command for at least one of the fuel injection nozzle and the distributor at the time when a piston position information supplied from the detection sensor shows that the piston has reached the predefined position.
